(19) United States
(12) Patent Application Publication
(10) Pub. No.: US 2012/0247234 A1
(43) Pub. Date: Oct. 4, 2012

(54) SYSTEM AND METHOD FOR SAMPLING A FLUID

(75) Inventors: Kelly Garrod, Lakewood, CO (US); Andrew Williams, Highlands Ranch, CO (US); Cameron Beul, Lakewood, CO (US)

(73) Assignee: Golder Associates, Inc., Lakewood, CO (US)

(21) Appl. No.: 13/075,587

(22) Filed: Mar. 30, 2011

(51) Int. Cl. G01N 1/00

(52) U.S. Cl. 73/864.81

(57) ABSTRACT

A system for sampling a fluid includes a conduit having an inner surface with a substantially constant, unobstructed diameter between upstream and downstream points. A sample line having an inlet and outlet provides fluid communication outside of the conduit. An inlet port in the sample line is radially inward from the upstream point and faces substantially upstream inside the conduit. A sensor is in fluid communication with the sample line. A method for sampling a fluid includes providing fluid communication through a sample line to a conduit having an inner surface with a substantially constant, unobstructed diameter between upstream and downstream points, wherein the sample line has an inlet port radially inward from an upstream point and facing substantially upstream inside the conduit. The method further includes flowing at least a portion of the fluid through a sensor in fluid communication with the sample line.

### FIELD OF THE INVENTION

The present invention generally involves a system and method for sampling a fluid. In particular embodiments of the present invention, the system and method may be used to sample and measure a fluid from a pipeline without requiring pumps or other mechanical devices to provide fluid flow to a sensor.

### BACKGROUND OF THE INVENTION

Various systems are known in the art for sampling fluids from a fluid pathway. For example, a batch sample of the fluid may be obtained from the fluid pathway and analyzed locally or remotely. However, batch sampling of the fluid does not allow for continuous monitoring of the fluids which may be desirable for proper operations. To obtain continuous monitoring, a sample line may be connected to the fluid pathway, and a pump may be used to provide continuous fluid flow through the sample line to a sensor. Alternately, a mechanical device, such as an orifice or other flow restrictor, may be installed in the fluid pathway to divert fluid flow through the sample line to the sensor. However, the need for a pump or other mechanical device to provide fluid flow to the sensor increases the complexity, costs, and maintenance associated with the system. Therefore, an improved system and method for sampling a fluid from a fluid pathway that does not require a pump or other mechanical device to provide fluid flow to the sensor would be useful.

### BRIEF DESCRIPTION OF THE INVENTION

Aspects and advantages of the invention are set forth below in the following description, or may be obvious from the description, or may be learned through practice of the invention.

One embodiment of the present invention is a system for sampling a fluid. The system includes a conduit configured for fluid flow from an upstream point to a downstream point. An inner surface of the conduit has a substantially constant, unobstructed diameter between the upstream point and the downstream point. A sample line has an inlet that passes through the conduit proximate to the upstream point and an outlet that passes through the conduit proximate to the downstream point so that the sample line provides fluid communication outside of the conduit from the upstream point to the downstream point. An inlet port in the sample line is radially inward from the upstream point and faces substantially upstream inside the conduit. A fluid characteristic sensor is in fluid communication with the sample line.

The present invention may also include a method for sampling a fluid that includes flowing the fluid through a conduit from an upstream point to a downstream point, wherein the conduit has an inner surface with a substantially constant, unobstructed diameter between the upstream point and the downstream point. The method further includes providing fluid communication from the upstream point to the downstream point through a sample line outside of the conduit, wherein the sample line has an inlet port radially inward from the upstream point and facing substantially upstream inside the conduit. In addition, the method includes flowing at least a portion of the fluid through a fluid characteristic sensor in fluid communication with the sample line.

In another embodiment, a method for sampling a fluid includes connecting a sample line to a conduit, wherein the conduit has an inner surface with a substantially constant, unobstructed diameter between an upstream point and a downstream point. The method further includes providing fluid communication from the upstream point to the downstream point through the sample line outside of the conduit, wherein the sample line has an inlet port radially inward from the upstream point and facing substantially upstream inside the conduit. In addition, the method includes flowing at least a portion of the fluid through a fluid characteristic sensor in fluid communication with the sample line.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a plan view of a system according to one embodiment of the present invention; and

FIG. 2 is a plan view of a system according to an alternate embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

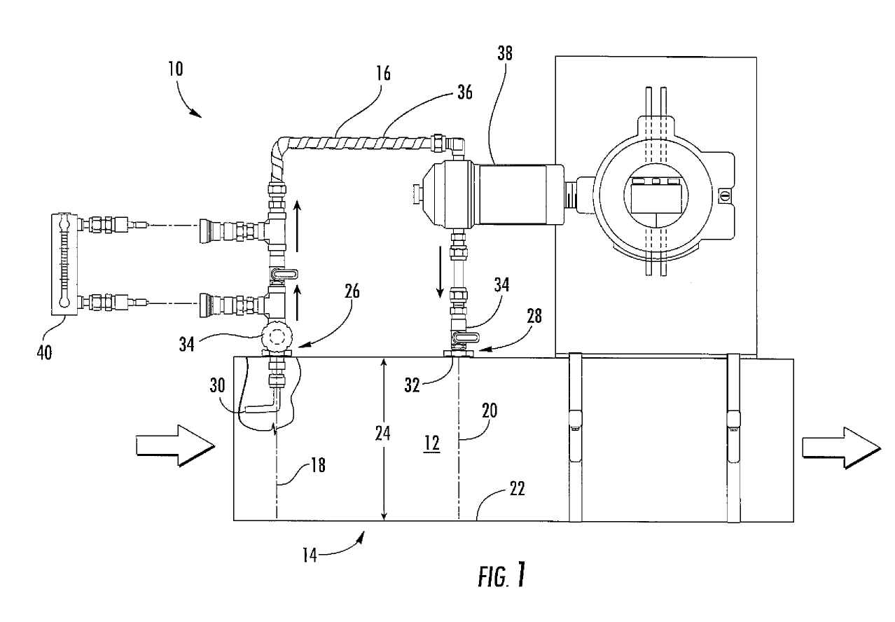

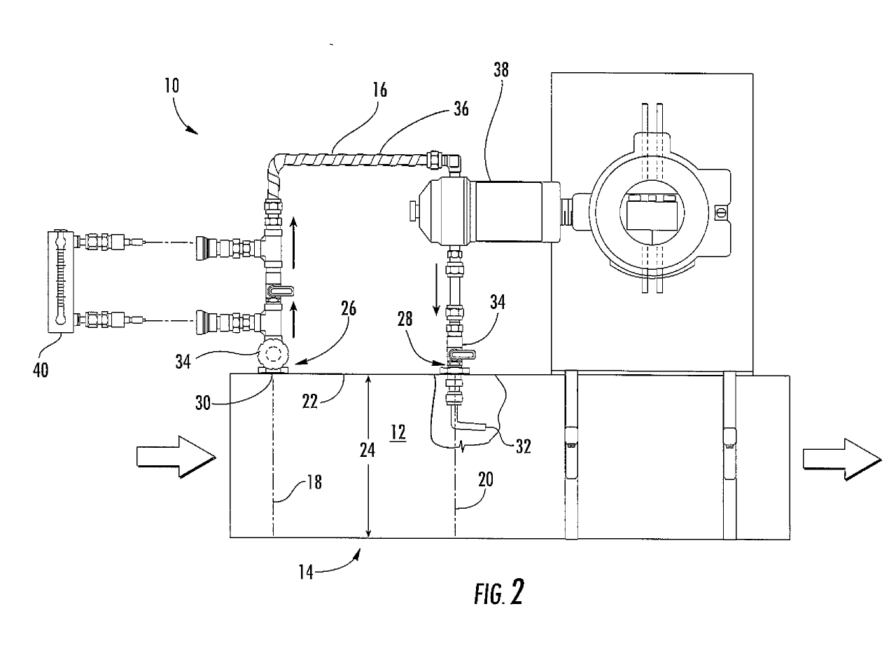

Various embodiments of the present invention provide a system 10 and method for sampling a fluid from a fluid pathway 12. For example, FIGS. 1 and 2 provide plan views of systems 10 according to various embodiments of the present invention. As shown, the system 10 generally includes a conduit 14 and a sample line 16. The conduit 14 may comprise any fluid system configured for fluid flow from an upstream point 18 to a downstream point 20. For example, the conduit 14 may comprise a pipe, tube, or other fluid pathway used to transport one or more gaseous or liquid fluids. The conduit 14 includes an inner surface 22 that has a substantially constant, unobstructed diameter 24 between the upstream point 18 and the downstream point 20. As used herein, the terms “upstream” and “downstream” refer to the relative location of points or components in the fluid pathway 12. For example, point A is upstream of point B if a fluid flows from point A to point B. Conversely, point B is downstream of point A if component B receives a fluid flow from point A. As used herein, the term “substantially constant” means that the diameter 24 of the inner surface 22 does not appreciably change between the upstream and downstream points 18, 20, other than acceptable changes associated with manufacturing tolerances of the conduit 14. As used herein, the term “unobstructed” means that the conduit 14 does not include additional components or mechanical devices between the upstream and downstream points 18, 20 that create a differential pressure or driving force across the component or mechanical device.

The sample line 16 includes an inlet 26 that passes through the conduit 14 at or proximate to the upstream point 18 and an outlet 28 that passes through the conduit 14 at or proximate to the downstream point 20. The inlet 26 of the sample line 16 extends inside the conduit 14 and terminates at an inlet port 30. As shown in FIG. 1, the inlet port 30 is located radially inward from the upstream point 18 and faces substantially upstream inside the conduit 14. The outlet 28 of the sample line 16 may terminate at an outlet port 32 coincident with the inner surface 22 of the conduit 14, as shown in FIG. 1. Alternately, as shown in FIG. 2, the outlet 28 of the sample line may extend inside the conduit 14 and terminate at the outlet port 32 located radially inward from the downstream point 20 and facing substantially downstream inside the conduit 14. As used herein, reference to the inlet and outlet ports 30, 32 facing “substantially upstream” or “substantially downstream” means that the respective ports are generally aligned, although in opposite directions, with the axial flow of the fluid through the fluid pathway 12. For example, in particular embodiments, the inlet and outlet ports 30, 32 may be aligned within 20 degrees, and preferably within 5 degrees, of the axial flow of the fluid through the fluid pathway 12, with the actual alignment determined by the desired flow rate through the sample line 16.

As shown in FIGS. 1 and 2, the sample line 16 may further include one or more isolation valves 34 proximate to the upstream and/or downstream points 18, 20 to allow isolation and/or intermittent operation of the system 10. In addition, the system 10 may further include means for heating the sample line 16 to reduce and/or prevent condensation from forming in the sample line 16. The means for heating the sample line 16 may comprise any suitable mechanism known in the art for maintaining and/or increasing the temperature of a fluid system. For example, the means for heating the sample line may comprise coils or heating strips 36 wrapped around some or all of the sample line 16, as shown in FIGS. 1 and 2.

In this manner, the sample line 16 provides fluid communication outside of the conduit 14 from the upstream point 18 to the downstream point 20. Specifically, with the inlet port 30 facing substantially upstream, the driving head of the fluid flowing through the conduit 14 allows at least a portion of the fluid to enter the inlet port 30 and flow through the sample line 16 outside of the conduit 14 before returning inside the conduit 14 through the outlet port 32. In the event that the outlet port 32 is located radially inward from the downstream point 20 and facing substantially downstream inside the conduit 14, as shown in FIG. 2, the fluid flowing in the conduit 14 past the outlet port 32 provides additional driving head to increase the fluid flow through the sample line 16.

As shown in FIGS. 1 and 2, the system 10 further includes one or more sensors in fluid communication with the sample line 16 that measure various parameters or characteristics of the fluid flowing through the conduit 14. For example, the system 10 may include a fluid characteristic sensor 38 in fluid communication with the sample line 16 that determines or measures a chemical characteristic of the fluid flowing through the conduit 14. The fluid characteristic sensor 38 may comprise, for example, one or more of a methane sensor, a carbon dioxide sensor, an oxygen sensor, a hydrogen sensor, a hydrogen sulfide sensor, a pH sensor, or a nitrogen sensor. In this manner, the fluid flowing through the sample line 16 may pass through the characteristic sensor 38 for measurement and/or analysis before returning to the conduit 14 through the outlet port 32. Alternately, or in addition, the system 10 may include a flow sensor 40 in fluid communication with the sample line 16 to determine or measure the fluid flow through the sample line 16. The flow sensor 40 may comprise, for example, one or more of a conventional differential pressure sensor, a pitot tube, or other device known in the art for measure fluid flow rates.

The systems 10 shown in FIGS. 1 and 2 may thus provide a method for continuously or intermittently sampling the fluid flowing through the conduit 14. The method may include flowing the fluid through the conduit 14 from the upstream point 18 to the downstream point 20 in which the inner surface 22 of the conduit 14 is substantially constant with an unobstructed diameter between the upstream and downstream points 18, 20. The method may further include providing fluid communication from the upstream point 18 to the downstream point 20 through the sample line 16 outside of the conduit 14 with the inlet port 30 radially inward from the upstream point 18 and facing substantially upstream inside the conduit 14. As a result, at least a portion of the fluid flows through the fluid characteristic sensor 38 in fluid communication with the sample line 16. In particular embodiments, the method may include sensing at least one of methane, carbon dioxide, oxygen, or nitrogen and/or sensing the fluid flow rate through the sample line 16.

The method may further include connecting the sample line 16 to the conduit 14 so that the inlet 26 passes through the conduit 14 at or proximate to the upstream point 18 and the outlet 28 passes through the conduit 14 at or proximate to the downstream point 20. Alternately, or in addition, the method may include connecting the sample line 16 to the conduit 14 so that the outlet port 32 is radially inward from the downstream point 20 and facing substantially downstream inside the conduit 14. In addition, the method they include isolating fluid flow through the sample line 16 and/or heating the sample line 16.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal languages of the claims.

What is claimed is:

1. A system for sampling a fluid, comprising:
a. a conduit configured for fluid flow from an upstream point to a downstream point;
b. an inner surface of the conduit, wherein the inner surface of the conduit has a substantially constant, unobstructed diameter between the upstream point and the downstream point;
c. a sample line having an inlet that passes through the conduit proximate to the upstream point and an outlet that passes through the conduit proximate to the downstream point, wherein the sample line provides fluid communication outside of the conduit from the upstream point to the downstream point;
d. an inlet port in the sample line radially inward from the upstream point, wherein the inlet port faces substantially upstream inside the conduit; and
e. a fluid characteristic sensor in fluid communication with the sample line.

2. The system as in claim 1, further comprising an outlet port in the sample line radially inward from the downstream point, wherein the outlet port faces substantially downstream inside the conduit.

3. The system as in claim 1, wherein the fluid characteristic sensor comprises at least one of a methane sensor, a carbon dioxide sensor, an oxygen sensor, or a nitrogen sensor.

4. The system as in claim 1, further comprising an isolation valve in the sample line proximate to at least one of the upstream point or the downstream point.

5. The system as in claim 1, further comprising a flow sensor in fluid communication with the sample line.

6. The system as in claim 1, further comprising means for heating the sample line.

7. A method for sampling a fluid, comprising:
a. flowing the fluid through a conduit from an upstream point to a downstream point, wherein the conduit has an inner surface with a substantially constant, unobstructed diameter between the upstream point and the downstream point;
b. providing fluid communication from the upstream point to the downstream point through a sample line outside of the conduit, wherein the sample line has an inlet port radially inward from the upstream point and facing substantially upstream inside the conduit; and
c. flowing at least a portion of the fluid through a fluid characteristic sensor in fluid communication with the sample line.

8. The method as in claim 7, further comprising connecting the sample line to the conduit, wherein the sample line has an inlet that passes through the conduit proximate to the upstream point and an outlet that passes through the conduit proximate to the downstream point.

9. The method as in claim 7, further comprising connecting the sample line to the conduit, wherein the sample line has an outlet port radially inward from the downstream point and facing substantially downstream inside the conduit.

10. The method as in claim 7, further comprising sensing at least one of methane, carbon dioxide, oxygen, or nitrogen.

11. The method as in claim 7, further comprising isolating fluid flow through the sample line.

12. The method as in claim 7, further sensing a fluid flow rate through the sample line.

13. The method as in claim 7, further comprising heating the sample line.

14. A method for sampling a fluid, comprising:
a. connecting a sample line to a conduit, wherein the conduit has an inner surface with a substantially constant, unobstructed diameter between an upstream point and a downstream point;
b. providing fluid communication from the upstream point to the downstream point through the sample line outside of the conduit, wherein the sample line has an inlet port radially inward from the upstream point and facing substantially upstream inside the conduit; and
c. flowing at least a portion of the fluid through a fluid characteristic sensor in fluid communication with the sample line.

15. The method as in claim 14, further comprising connecting the sample line to the conduit, wherein the sample line has an inlet that passes through the conduit proximate to the upstream point and an outlet that passes through the conduit proximate to the downstream point.

16. The method as in claim 14, further comprising connecting the sample line to the conduit, wherein the sample line has an outlet port radially inward from the downstream point and facing substantially downstream inside the conduit.

17. The method as in claim 14, further comprising sensing at least one of methane, carbon dioxide, oxygen, or nitrogen.

18. The method as is claim 14, further comprising isolating fluid flow through the sample line.

19. The method as in claim 14, further sensing a fluid flow rate through the sample line.

20. The method as in claim 14, further comprising heating the sample line.
